(19) United States
(12) Patent Application Publication
(10) Pub. No.: US 2017/0026759 A1
(43) Pub. Date: Jan. 26, 2017

(54) MICROPHONE WITH WIND NOISE RESISTANCE

(71) Applicant: Knowles Electronics, LLC, Itasca, IL (US)

(72) Inventor: Weiwen Dai, Elgin, IL (US)

(73) Assignee: Knowles Electronics, LLC, Itasca, IL (US)

(21) Appl. No.: 15/215,752

(22) Filed: Jul. 21, 2016

Related U.S. Application Data
(60) Provisional application No. 62/196,586, filed on Jul. 24, 2015.

(51) Int. Cl. H04R 17/02

(52) U.S. Cl. CPC H04R 17/02; H04R 2201/003

(57) ABSTRACT

A microphone device is comprises a first micro electro mechanical system (MEMS) device and a second MEMS device with difference size of pierce holes in the diaphragms. Signal outputs from the first and second MEMS devices are selectively used to provide wind noise resistance.

### CROSS-REFERENCE TO RELATED APPLICATIONS

This application claims the benefit of and priority to U.S. Provisional Patent Application No. 62/196,586, filed Jul. 24, 2015, the entire contents of which are incorporated herein by reference.

### TECHNICAL FIELD

This application relates to microphones and, more specifically, microphones that provide wind noise resistance.

### BACKGROUND OF THE INVENTION

Different types of acoustic devices have been used through the years. One type of device is a microphone. In a microelectromechanical system (MEMS) microphone, a MEMS die includes a diagram and a back plate. The MEMS die is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential with respect to the back plate, which creates an electrical signal. Microphones are deployed in various types of devices such as personal computers or cellular phones.

Wind noise can be a problem in many applications. For example, when a listener is wearing a hearing aid and windy conditions exist, it may be difficult to for the listener to distinguish sounds because of the wind. Additionally, for example when using a cellular phone, when windy conditions exist a microphone may pick up the wind as noise making it difficult or impossible for a listener to distinguish the desired voice communication over the wind.

Various approaches have been utilized in an attempt to alleviate the problems concerned with windy conditions. The problems of previous approaches have resulted in some user dissatisfaction with these previous approaches.

### SUMMARY

In general, one aspect of the subject matter described in this specification can be embodied in a microphone. The microphone comprises a first micro electro mechanical system (MEMS) device, a second MEMS device, and an application specific integrated circuit (ASIC) coupled to the first and second MEMS devices. The first MEMS device includes a first diaphragm and a first back plate. The first diaphragm has a first pierce hole of a first size. The second MEMS device includes a second diaphragm and a second back plate. The second diaphragm has a second pierce hole of a second size greater than the first size. The ASIC is configured to selectively use a first signal output from the first MEMS device and a second signal output from the second MEMS device.

Another aspect of the subject matter can be embodied in a microphone. The microphone comprises a first sensor, a second sensor, and an ASIC coupled to the first and second sensors. The first sensor is configured to receive sound energy from a first acoustic circuit and convert the sound energy into a first electrical signal. The first acoustic circuit provides a first frequency roll off The second sensor is configured to receive the sound energy from a second acoustic circuit and convert the sound energy into a second electrical signal. The second acoustic circuit provides a second frequency roll off higher than the first frequency roll off The ASIC is configured to selectively mix the first electrical signal and the second electrical signal.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A comprises a block diagram of a microphone that provides a blended analog output according to various embodiments of the present invention.

FIG. 1B comprises a block diagram of a close-up of portions of the microphone of FIG. 1A according to various embodiments of the present invention.

FIG. 2 comprises a table showing the operation of the microphone of FIGS. 1A and 1B according to various embodiments of the present invention.

FIG. 3 comprises a block diagram of a microphone that provides a blended analog output according to various embodiments of the present invention.

FIG. 4 comprises a graph showing the operation of the microphone of FIG. 3 according to various embodiments of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### DETAILED DESCRIPTION

The present approaches provide two micro electro mechanical system (MEMS) devices. These are sensor devices that convert sound energy into electrical signals. One or more housings can enclose the sensor devices. The housing can have a port (or hole or opening) that extends through the housing so that sound energy can enter the interior. The sound energy can move the diaphragm and with the back plate create an electrical signal that is representative of the sound energy. The first diaphragm has a first pierce hole, (or opening), with a first size and the second diaphragm with a second pierce hole (or opening) with a second size, with the second size being significantly greater than the first size. A controller looks at energy at particular frequencies. If there is a lot of energy (e.g., energy above a predetermined threshold) at low frequencies, it means that there is wind and then the system is operated with the microphone having the large pierce hole or opening. Otherwise, the system is operated with the microphone having the smaller pierce hole or opening. In one aspect, the operation is controlled by switches.

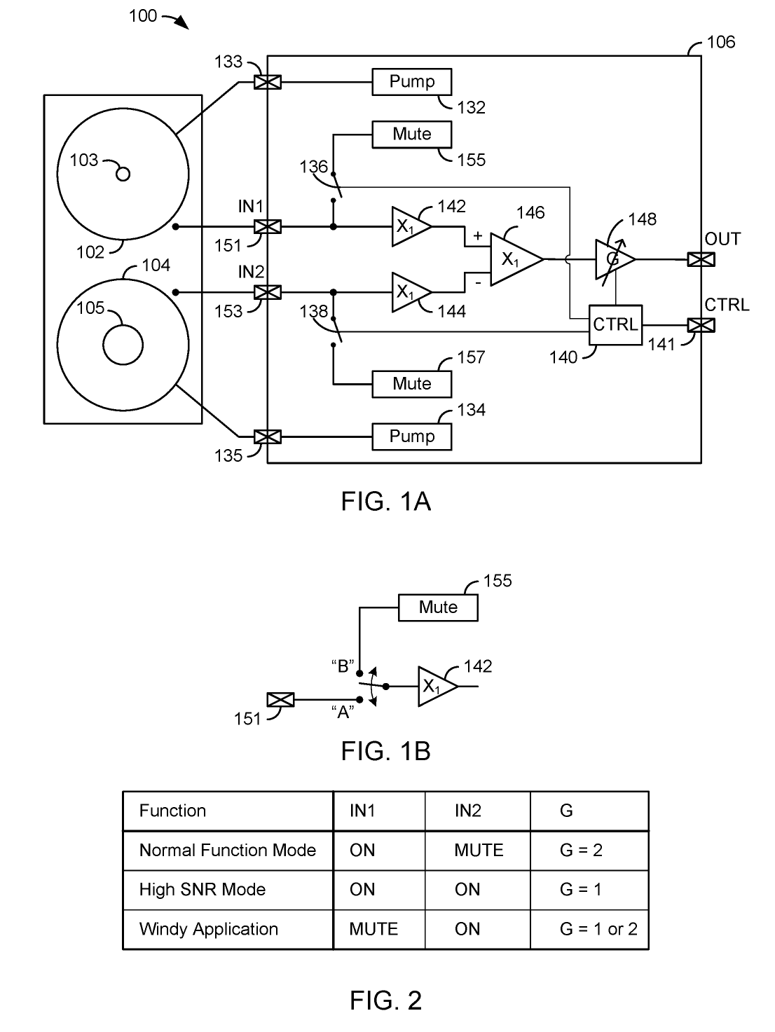

Referring now to FIG. 1A and FIG. 1B, one example of a microphone 100 is described. The microphone 100 includes a first micro electro mechanical system (MEMS) device 102, a second MEMS device 104, and an application specific integrated circuit (ASIC) 106 coupled to the first and second MEMS devices 102 and 104.

The first MEMS device 102 includes a housing, a first diaphragm, and a first back plate. Sound energy enters via a port (not shown in the present figures), moves the first diaphragm, and this creates a first electrical signal. The diaphragm has a pierce 103 (or opening, or hole) of a first size. By “size,” it is meant diameter, circumference, or some other measure of how the large the pierce 103 is in the diaphragm.

The second MEMS device 104 includes a housing, a second diaphragm, and a second back plate. Sound energy enters via the port, moves the second diaphragm, and this creates a second electrical signal. It will be appreciated that rather than having two housings, the housings of the first and second MEMS devices 102 and 104 may be combined into a single housing. The second diaphragm has a pierce opening 105 of a second size. The second size is greater (e.g., significantly greater) than the first size. In one example, the first pierce opening is 4-10 μm in size and the second pierce opening is 20-40 μm in size. Other examples of sizes are possible.

The ASIC 106 includes a first charge pump 132 (coupled to output 133), a second charge pump 134 (coupled to output 135), a first switch 136, a second switch 138, a controller 140 (coupled to control input 141), a first amplifier 142, a second amplifier 144, a third amplifier 146, and a fourth amplifier (with adjustable gain) 148 (gain controlled by controller 140).

The first charge pump 132 is coupled to the first MEMS device 102 via the output 133. The second charge pump 134 is coupled to the second MEMS device 104 via the output 135. The first switch 136 and the second switch 138 are coupled to the controller 140. The controller 140 controls whether the switches 136 and 138 are open or closed. When the switches are in position “B”, signals from input 151 and 153 are transmitted through amplifiers 142 and 144. When the switches are in position “A”, then the signals from inputs 151 and 153 go to mute boxes 155 and 157 (which may be circuit ground in one example). In other words, when either of the switches is closed, the corresponding input signal is muted. Because of the difference in pierce opening sizes through the respective diaphragms of the respective MEMS devices, the MEMS can be selected such that when windy conditions occur the MEMS device with the larger pierce (more suitable for handling wind energy) is selected for use.

The controller looks at the energy at particular frequencies. If there is a lot of energy (above a predetermined threshold) at low frequencies (below a selected frequency), then the controller operates the microphone in the windy mode (i.e., mute the IN1 input). Otherwise the controller operates the microphone with IN1 or both IN1 and IN2.

Referring now to FIG. 2. In one example of the operation of the apparatus of FIG. 1A and FIG. 1B, in a normal functional mode, IN1 is on, IN2 is muted, and G=2. In a mode where there is a high signal to noise ratio (SNR), IN1 is on, IN2 is on, and G=1. In windy applications, IN1 is muted, IN2 is on, and G=1 or 2.

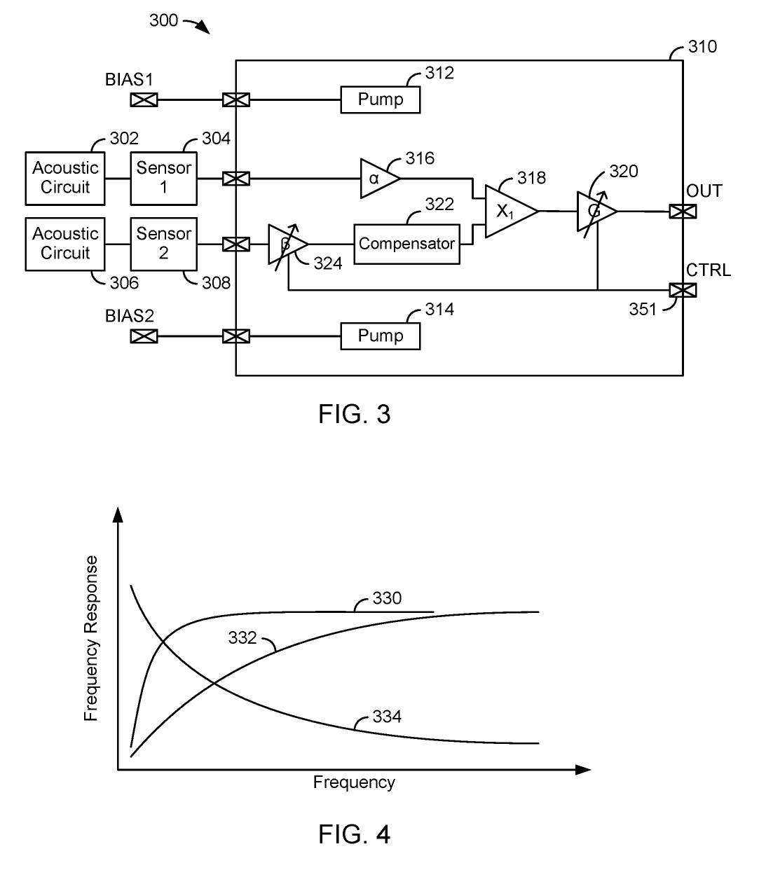

Referring now to FIG. 3 and FIG. 4, another example of a microphone is described. The microphone 300 includes a first acoustic circuit 302, a first sensor 304, a second acoustic circuit 306, a second sensor 308, and an ASIC 310. The ASIC 310 includes a first charge pump 312, a second charge pump 314, a first amplifier 316, a second adjustable gain amplifier 324, a third amplifier 318, a fourth adjustable gain amplifier 320 (controlled for example by a controller), and a compensation element 322. The charge pumps 312 and 314 provide electrical charge or bias to the sensors 304 and 308.

The first acoustic circuit 302 and the second acoustic circuit 306 provide acoustic paths and may be pipes or part of the casing. The first and second acoustic circuits 302 and 306 may simulate the effects of different holes or punctures in the diaphragms of the first MEMS device and the second MEMS device.

The first sensor 304 and the second sensor 308 receive sound energy and convert the sound energy into electrical signals. In one example, they are MEMS elements but also may be piezoelectric elements to name another example. Other examples are possible.

The ASIC 310 is an integrated circuit that includes a first charge pump 312 and a second charge pump 314, which power the sensors 304 and 308. The first amplifier 316, second amplifier 324, amplify signals from each sensor and each has an associated gain. In one example, the first amplifier 316 has a unity gain, and the second amplifier 324 has an adjustable gain of β. The third amplifier 318 acts as a mixer and the fourth amplifier 320 normalizes the signal. The adjustable gains are controlled by an external control circuit via control pin 351. In other aspects, the controller or control circuit can be disposed at ASIC 310. The compensation element 322 provides controlled delay or phase adjustment between signals from the sensors 302 and 308. The controller looks at the energy at particular frequencies in order to make its determinations of the gains. The controller can be internal or external to the ASIC 310 or the microphone 300.

In operation, sound is received by the first acoustic circuit 302 (and sensed by the first sensor 304) and the second acoustic circuit 306 (and sensed by the second sensor 308). The first sensor 304 and the second sensor 308 convert the sound energy into electrical signals. As shown in FIG. 4, the first acoustic circuit 302 provides a low roll off as shown by curve 330, the second acoustic circuit 306 provides a high roll off as shown by curve 332. The bias voltages of the pumps 312 and 314 are of opposite polarities. For example, the bias of the first pump may be +30V, and the bias of the second −11V. Other examples are possible.

In other aspects, IN1 and IN2 are output of phase signals from sensors, which are biased by opposite bias voltages. Amplifier 324 gains IN2 by a factor β. Compensation element 322 performs phase compensation to IN2 with respect to IN1. In one aspect, the output of third amplifier 320 is (1/(α+β))*(α*IN1−β*IN2) with IN2 out of phase of IN1.

In one example, α=1, β=0 for high signal-to-noise ratio (SNR) signal output with lowest low frequency roll off.

In another example, α=0, β=1 for a windy situation with highest low frequency roll off.

In still another example, α+β=1. Set low frequency roll off between the minimum frequency and maximum frequency.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A microphone comprising:
a first micro electro mechanical system (MEMS) device that includes a first diaphragm and a first back plate, wherein the first diaphragm has a first pierce hole of a first size;
a second MEMS device that includes a second diaphragm and a second back plate, wherein the second diaphragm has a second pierce hole of a second size greater than the first size; and
an application specific integrated circuit (ASIC) coupled to the first MEMS device and the second MEMS device, wherein the ASIC is configured to selectively use a first signal output from the first MEMS device and a second signal output from the second MEMS device.

2. The microphone of claim 1, wherein the first MEMS device and the second MEMS device have different cutoff frequencies.

3. The microphone of claim 1, wherein the ASIC is further configured to monitor sound energy at particular frequencies received by the first MEMS device and the second MEMS device and to selectively use the first and second signals based on the sound energy monitored.

4. The microphone of claim 3, wherein the ASIC is further configured to mute the first signal and use the second signal in a windy mode in which the sound energy at frequencies lower than a threshold frequency exceeds a threshold sound energy.

5. The microphone of claim 3, wherein the ASIC is further configured to mute the second signal and use the first signal in a normal function mode in which the sound energy at frequencies lower than a threshold frequency does not exceed a threshold sound energy.

6. The microphone of claim 3, wherein the ASIC is further configured to use both the first and second signals in a high SNR mode in which a signal to noise ratio (SNR) of the sound energy exceeds a threshold SNR.

7. The microphone of claim 1, wherein the ASIC comprises a first charge pump configured to power the first MEMS device, and a second charge pump configured to power the second MEMS device.

8. The microphone of claim 1, wherein the ASIC is further configured to adjust a gain of the first signal and the second signal.

9. The microphone of claim 1, wherein the first MEMS device is disposed in a first housing, and wherein the second MEMS device is disposed in a second housing.

10. The microphone of claim 1, wherein the first MEMS device and the second MEMS device are disposed in a housing.

11. A microphone comprising:
a first sensor configured to receive sound energy from a first acoustic circuit and convert the sound energy into a first electrical signal, wherein the first acoustic circuit provides a first frequency roll off;
a second sensor configured to receive the sound energy from a second acoustic circuit and convert the sound energy into a second electrical signal, wherein the second acoustic circuit provides a second frequency roll off higher than the first frequency roll off; and
an application specific integrated circuit (ASIC) coupled to the first sensor and the second sensor, wherein the ASIC is configured to selectively mix the first electrical signal and the second electrical signal.

12. The microphone of claim 11, wherein at least one of the first sensor and the second sensor is a micro electro mechanical system (MEMS) element.

13. The microphone of claim 11, wherein at least one of the first sensor and the second sensor is a piezoelectric element.

14. The microphone of claim 11, wherein the ASIC comprises a first charge pump to power the first sensor, and a second charge pump to power the second sensor, and wherein the first and second charge pumps are biased with opposite polarities.

15. The microphone of claim 11, wherein the ASIC comprises a compensation element configured to provide a delay or phase adjustment between the first electrical signal and the second electrical signal.

16. The microphone of claim 11, wherein the ASIC is further configured to monitor sound energy at particular frequencies received by the first acoustic circuit and the second acoustic circuit and to selectively mix the first and second electrical signals based on the sound energy monitored.

17. The microphone of claim 16, wherein the ASIC is further configured to add the first electrical signal with a first gain and the second electrical signal with a second gain, and wherein the first gain and the second gain are adjusted based on sound energy monitored.

18. The microphone of claim 16, wherein the ASIC is further configured to set the second gain to be zero and the first gain higher than zero in response to the sound energy with a minimum low frequency roll off.

19. The microphone of claim 16, wherein the ASIC is further configured to set the first gain to be zero and the second gain higher than zero in response to the sound energy with a maximum low frequency roll off.

20. The microphone of claim 16, wherein the ASIC is further configured to set both the first and second gains higher than zero in response to the sound energy with a low frequency roll off between a minimum low frequency roll off and a maximum low frequency roll off.
